(19) United States
(12) Patent Application Publication
(10) Pub. No.: US 2011/0232783 A1
(43) Pub. Date: Sep. 29, 2011

(54) APPARATUS FOR FLUID SUPPLY AND CONTROL OF A FLUIDIC SYSTEM

(75) Inventor: FRANK K. GEHRING, OBERNHEIM (DE)

(73) Assignee: ANDREAS HETTICH GMBH & CO. KG, TUTTLINGEN (DE)

(21) Appl. No.: 13/053,212

(22) Filed: Mar. 22, 2011

(30) Foreign Application Priority Data
Mar. 23, 2010 (DE) 102010016106.3-14

(51) Int. Cl. F15D 1/00

(52) U.S. Cl. 137/560

(57) ABSTRACT

The invention relates to an apparatus (10) for fluid supply and control of a fluidic system comprising a housing (12), a control unit integrated into the housing (12), as well as at least one pump integrated into the housing (12) and at least one valve integrated into the housing (12) which are connected to the control unit by signal technology and which are adapted to be controlled by the control unit, wherein the housing (12) comprises a connection plate (24, 26) comprising standardized fluidic connection means (14, 16, 20) accessible from the outside for connected external fluidic connections, and wherein the at least one pump and the at least one valve (22) are connected to the connection means (14, 16, 20) of the connection plate (24, 26) in the interior of the housing (12).

The invention relates to an apparatus for fluid supply and control of a fluidic system.

A more or less variable usage of pumps and valves is always of primary concern in fluidic measurement arrangements. According to the state of the art, a control software of its own has to be programmed for each measurement arrangement. The valves and pumps are usually accessed through serial interfaces. Accordingly, the drivers have to be also integrated into the specially programmed control software. This is not always easy and requires sufficient export knowledge. Unfortunately, sufficient knowledge about programming is not always available from persons which carry out fluidic measurements.

The invention provides an apparatus for supplying and controlling a fluidic system using simple inputs without special knowledge.

The apparatus of the invention is provided with at least one pump, at least one valve and at least one control unit which are housed in a common housing. The pumps and valves can be accessed in a simple way through the control unit.

In particular, the control unit may be operated by a touch panel which is also integrated into the housing.

The connection means of the pump and the valves are connected without leakage to the connection means of the housing. The connection means can, therefore, be accessed and connected externally. The valves and pumps are connected to the control unit.

By means of this apparatus, the user is in a position to generate a functioning fluidic system quickly and easily such that the respective valves are simply, effectively, and fluidically connected from the exterior of the housing through the connection plate.

Pump velocity and valve positions can be transmitted through control listings to the control system. The user does not have to worry about the communication between the control system and the pumps and valves. This is already previously implemented and defined in the control system. In spite of this, possibilities to make inputs are provided also to access the apparatus driver directly.

In a particularly advantageous embodiment, the components are arranged in a hatch. By means of this hatch, the pumps and valves are accessible which allows the standardized connections to be changed and also allows the adaptation to special cases. This is, for example, important in case short fluidic pathways are necessary.

A further advantage of the invention results from the possibility to synchronize the fluidic control with other systems. For this purpose, in particular an interface for a TTL-signal is provided. The TTL-signal can be received as well as transmitted. The TTL-signal triggers and stops the process sequence. This is of great importance in particular for connected measurement systems.

Besides TTL-signals, the apparatus can comprise further interfaces. As known per se, those are LAN, USB, Firewire, RS 488, RS 232, screens etc. By means of such interfaces, for example the protocols generated by the control unit can be stored or printed out. Furthermore, the control listings can be input through these interfaces.

The control listings can be in Excel format or just tab-stop-separated .txt data or similar, common, digital listing formats.

In a further advantageous embodiment, two pumps and two valves are provided. This allows mixing of fluids. The valves each comprise an input pathway which can be connected, depending on the switch position, with four output pathways. The switch positions can be adjusted time dependently by control listings.

Any fluidic systems can be connected through the standardized connections at the connection plate. This is particularly true for micro fluidic platforms which can be connected, thereby, with a fluidic supply and control unit in a simple way.

Further advantages, features and possibilities of usage of the present invention can be taken from the following description in connection with the embodiments shown in the drawings.

The invention is described in more detail in the following with reference to the embodiment shown in the drawing. In the specification, the claims and the drawing the reference signs are related to the terms which are used in the list of reference signs given below.

In the drawing:

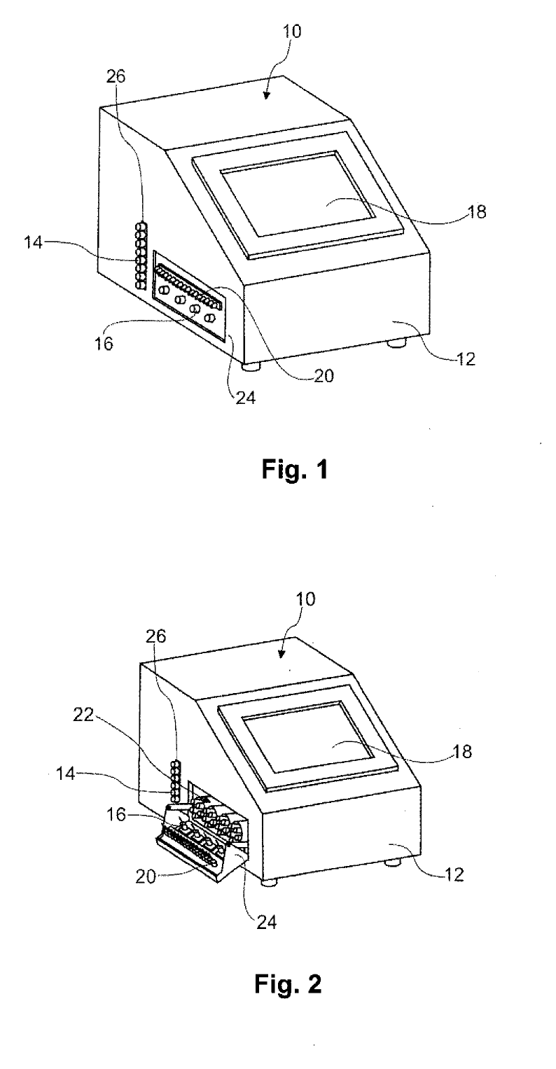

FIG. 1 is a perspective view of a fluidic control apparatus; and

FIG. 2 is a perspective view of the fluidic supply system with opened revision hatch.

FIG. 1 shows a perspective view of a fluidic supply system 10 in a housing 12. Within the housing 12, four pumps are arranged which are connected without leakage with their inputs and outputs to standardized connection means. By means of such pump connection means 14, for example supply containers, fluidic circuits or valves integrated within the housing, can be connected. The valves within the housing are also connected with valve connection means 16 at the housing. The connection means are also standardized. In this embodiment, the valves comprise an input and four outputs each. The valves can, therefore, be contacted through standardized fluidic connections from the outside. Therefore, a micro fluidic system can be connected together in a simple way.

The pump connections 14 are all together received in a connection plate 26 which comprises a part of the housing wall of the apparatus. The valve connections 16, 20 are, however, arranged in a separate revision hatch 24. The valves 22 may be operated as selector as well as distribution valves. In the case of a selector operation, the connections 16, the inputs and the four respectively associated connections 20 form the outputs of the valve. In the other case, the allocation is reversed.

Furthermore, a computer unit is integrated in the housing 12. The pumps and valves are connected to the computer unit by means of serial interfaces. The computer unit fulfils the task to control the fluidic supply system 10. In order to transmit process sequences to the control unit, simple listings can be transmitted to the control unit. The transmission of the input listings can be effected through interfaces provided. The respective interfaces are LAN, USB and Firewire.

In order to provide a further interface between human being and machine, a touch panel 18 is integrated in the housing 12. By means of this touch panel 18, configuration adjustments can be made or process sequence listings can be generated.

This apparatus has the advantage that any fluidic system can be operated and supplied through standardized connections. Therefore, the user does not have to care anymore about integration but can easily determine, for example through Excel listings, a process sequence. Furthermore, the fluidic system can be synchronized through TTL-signals with other systems, in particular measurement systems.

FIG. 2 shows a fluidic supply apparatus with opened revision hatch 24 in a perspective view. The connection plate on which the fluidic connections 16, 20 are arranged, is configured as revision hatch 24. The revision hatch 24 allows the access to the valves 22 so that the user may make special configuration adjustments. This can be important when especially short fluidic pathways are necessary, for example. Furthermore, it allows the exchange and maintenance, respectively, of the valves 22.

By means of this apparatus, a user is put into a position to easily and quickly assemble a fluidic system with predefined interconnection possibilities without programming knowledge.

### LIST OF REFERENCE SIGNS

10 fluidic supply system
12 housing
14 pump connections
16 valve input
18 touch panel
20 valve output
22 valves
24 revision hatch
26 connection plate

1-6. (canceled)

7. Apparatus for fluid supply and control of a fluidic system comprising:
a housing, said housing includes an interior and an exterior;
a control unit;
said control unit integrated into said housing, a pump integrated into said housing, and a valve integrated into said housing;
signal means;
said signal means interconnecting said control unit, said valve and said pump;
said control unit controlling said pump and said valve;
said housing includes a connection plate comprising standardized fluidic connection means;
said standardized fluidic connection means are accessible from said exterior of said housing; and,
said pump and said valve are connected to said connection means of said connection plate in said interior of said housing.

8. Apparatus according to claim 7, further comprising a touch panel, said touch panel integrated with said housing, said touch panel includes input means for control of said apparatus.

9. Apparatus according to claim 1, wherein said housing further includes a revision hatch and said pump and said valve are accessibly mounted behind said revision hatch.

10. Apparatus according to claim 7, wherein a process sequence may be defined by means of input listings.

11. Apparatus according to claim 7, further comprising an interface for a TTL-signal allowing synchronization with other instruments.

12. Apparatus according to claim 11, further comprising interfaces selected from the group of CAN, Ethernet and USB, are integrated into said apparatus enabling functional interaction with other components.
